(19) United States
(12) Patent Application Publication
(10) Pub. No.: US 2013/0017506 A1
(43) Pub. Date: Jan. 17, 2013

(54) ORTHODONTIC DEVICE

(71) Applicant: Stan Parker, Indian Rocks Beach, FL (US)

(72) Inventor: Stan Parker, Indian Rocks Beach, FL (US)

(73) Assignee: PARKER ORTHODONTICS, Indian Rocks Beach, FL (US)

(21) Appl. No.: 13/184,567

(22) Filed: Jul. 17, 2011

(51) Int. Cl. A61C 7/28; A61C 7/00

(52) U.S. Cl. 433/24; 433/9

(57) ABSTRACT

In some implementations at least one orthodontic tooth-bonding-pad is attached to an archwire through a sheath. In some implementations, a tooth-bonding-pad has a passageway through which an archwire can be placed.

### FIELD

This disclosure relates generally to orthodontic devices, and more particularly to orthodontic archwire devices.

### BACKGROUND

In orthodontics, an orthodontic archwire is ligated to a number of orthodontic brackets, each of which has a tooth-bonding-pad as a part of a bracket. An orthodontic archwire is a wire conforming to the alveolar or dental arch that can be used with dental tooth-bonding pads and brackets as a source of force in correcting irregularities in the position of the teeth. The dental tooth-bonding pads are attached to the brackets and the brackets are attached to the archwire. The archwire is attached to the brackets by an Orthodontist in the mouth of a patient.

### BRIEF DESCRIPTION OF THE DRAWINGS

FIG. 1 is a block diagram of an overview of a unitary tooth-bonding-pad/archwire system, according to an implementation having 6 tooth-bonding pads;

FIG. 2 is a distal or mesial view of a cross section block diagram of a device according to an implementation illustrating an archwire exiting or protruding from an interior of a tooth-bonding-pad;

FIG. 3 is an occlusal view of a cross section block diagram of a device according to an implementation illustrating an archwire exiting or protruding from an interior of a tooth-bonding-pad;

FIG. 4 is a buccal view of a cross section block diagram of a device according to an implementation illustrating an archwire exiting or protruding from an interior of a tooth-bonding-pad;

FIG. 5 is a distal or mesial view of a cross section block diagram of a device according to an implementation illustrating an archwire passageway in an interior of a tooth-bonding-pad;

FIG. 6 is an occlusal view of a cross section block diagram of a device according to an implementation illustrating an archwire passageway in an interior of a tooth-bonding-pad;

FIG. 7 is a buccal view of a cross section block diagram of a device according to an implementation illustrating an archwire passageway in an interior of a tooth-bonding-pad;

FIG. 8 is a distal or mesial view of a cross section block diagram of a unitary tooth-bonding-pad/archwire a device attached externally to a tooth, according to an implementation;

FIG. 9 is an occlusal view of a cross section block diagram of a device according to an implementation illustrating an archwire removably attached to a side of a tooth-bonding-pad;

FIG. 10 is a buccal view of a cross section block diagram of a device according to an implementation illustrating an archwire removeably attached to a side of a tooth-bonding-pad;

FIG. 11 is isometric view of a prior art example of an orthodontic bracket that is not included in FIGS. 1-10 and 12-18.

FIG. 12 is a flowchart of a method to fabricate a unitary tooth-bonding-pad/archwire device according to an implementation;

FIG. 13 is a flowchart of a method to fabricate a unitary tooth-bonding-pad/archwire device according to an implementation;

FIG. 14 is a flowchart of a method to implement a unitary tooth-bonding-pad/archwire device, according to an implementation before application of removable orthodontic appliance systems;

FIG. 15 is a flowchart of a method to implement a unitary tooth-bonding-pad/archwire device, to correct orthodontic relapse;

FIG. 16 is a flowchart of a method to implement a unitary tooth-bonding-pad/archwire device, to facilitate the application of interceptive removable orthodontic devices on patients who are in a mixed dentition age range;

FIG. 17 is a flowchart of a method to implement a unitary tooth-bonding-pad/archwire device, to correct a minor orthodontic malocclusion; and

FIG. 18 is a flowchart of a method to implement a unitary tooth-bonding-pad/archwire device, in coordination with application of crowns and abutments.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, physical and other changes may be made without departing from the scope of the implementations. The following detailed description is, therefore, not to be taken in a limiting sense.

In one aspect, at least one tooth-bonding-pad is directly attached to a sheathing of an archwire.

In one other aspect, a device consists of an archwire and a plurality of tooth-bonding-pads. In some implementations, each of the plurality of tooth-bonding-pads is permanently fabricated to the archwire at fixed positions of the archwire. In some implementations, each of the plurality of tooth-bonding-pads is permanently fabricated into the archwire at fixed positions of the archwire. In some implementations, each of the plurality of tooth-bonding-pads is permanently fabricated onto the archwire at fixed positions of the archwire.

In another aspect, a device consists essentially of an archwire and a plurality of tooth-bonding-pads. In some implementations, each of the plurality of tooth-bonding-pads is permanently fabricated into the archwire at fixed positions of the archwire.

In yet another aspect, a device includes an archwire and a plurality of tooth-bonding-pads. In some implementations, each of the plurality of tooth-bonding-pads is permanently fabricated into the archwire at fixed positions of the archwire.

In still yet another aspect, a device consists of an archwire and at least one tooth-bonding-pad directly attached to the archwire.

In still yet a further aspect, a device consists essentially of an archwire and at least one tooth-bonding-pad directly attached to the archwire.

In still a further aspect, a device comprises an archwire and at least one tooth-bonding-pad directly attached to the archwire.

In still another aspect, a method includes setting typodont teeth in orthodontically correct positions, placing a plurality of tooth-bonding-pads onto the typodont teeth in the occlusal-gingival center and mesial-distal center of the labial and buccal aspect of orthodontically correct positions, and attaching permanently an archwire to the exterior surface of each of the plurality of the tooth-bonding-pads in a plane.

In a further aspect, a method includes setting typodont teeth in orthodontically correct positions, placing a plurality of tooth-bonding-pads onto the typodont teeth in the occlusal-gingival center and mesial-distal center of the labial and buccal aspect of orthodontically correct positions, and forming an archwire to an exterior surface of each of the plurality of the tooth-bonding-pads in a horizontal plane.

In yet a further aspect, an orthodontic device having an archwire and at least one tooth-bonding-pad does not include an orthodontic bracket.

In an additional aspect, a device consists of a tooth-bonding-pad having a passageway, the passageway extending through the tooth-bonding-pad along a mesial-distal length and perpendicular to an occlusal-gingival length.

In yet another additional aspect, a device includes a tooth-bonding-pad having a passageway, the passageway extending through the tooth-bonding-pad along a mesial-distal length and perpendicular to an occlusal-gingival length.

Apparatus, systems, and methods of varying scope are described herein. In addition to the aspects and advantages described herein, further aspects and advantages will become apparent by reference to the drawings and by reading the detailed description that follows.

The detailed description is divided into four sections. In the first section, a system level overview is described. In the second section, apparatus of implementations are described. In the third section, implementations of methods are described. Finally, in the fourth section, a conclusion of the detailed description is provided.

### System Level Overview

A system level overview of the operation of an implementation is described in this section of the detailed description.

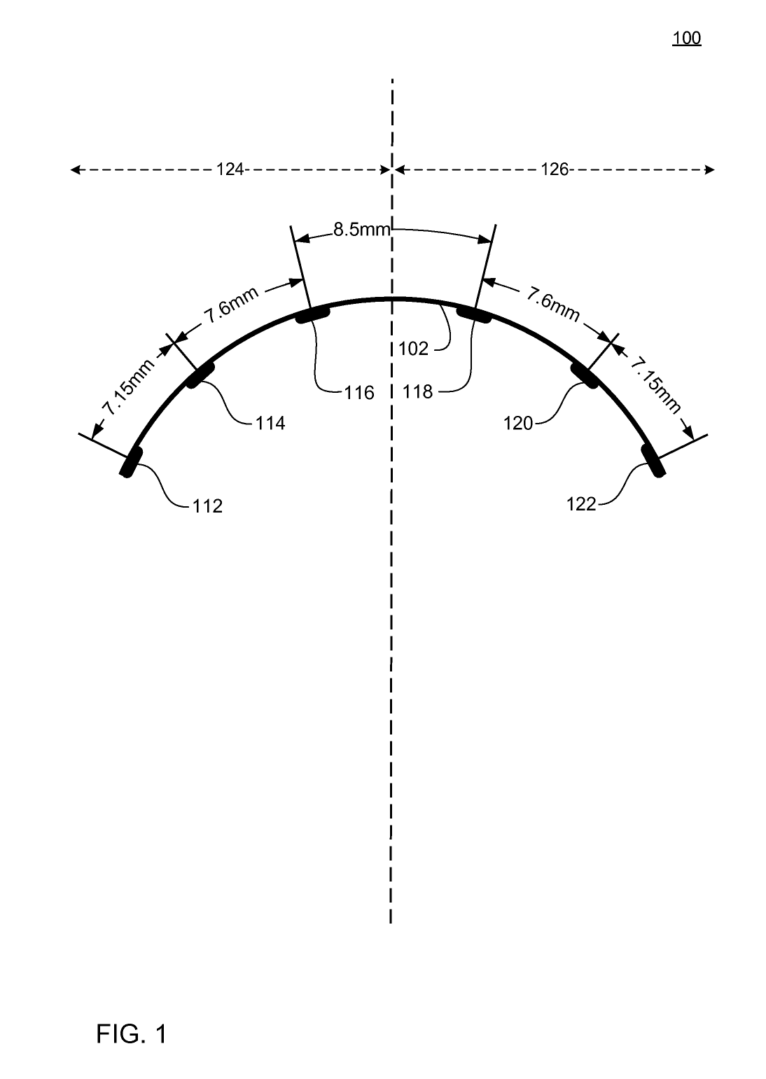

FIG. 1 is a block diagram of an overview of a unitary tooth-bonding-pad/archwire system 100, according to an implementation having 6 tooth-bonding pads. System 100 can be described as a single-bonded archwire.

System 100 includes an archwire 102 and a plurality of tooth-bonding-pads 112, 114, 116, 118, 120 and 122. Each of the plurality of tooth-bonding-pads 112-122 are permanently fabricated to the archwire 102 at fixed positions of the archwire 102. In some implementations, the tooth-bonding-pads 112-122 are metallic, such as stainless steel. In some implementations, the tooth-bonding-pads 112-122 include fused alumina particles. In some implementations, the tooth-bonding-pads 112-122 are made of materials that are not saliva soluble and that are not galvanically reactive, such as ceramic.

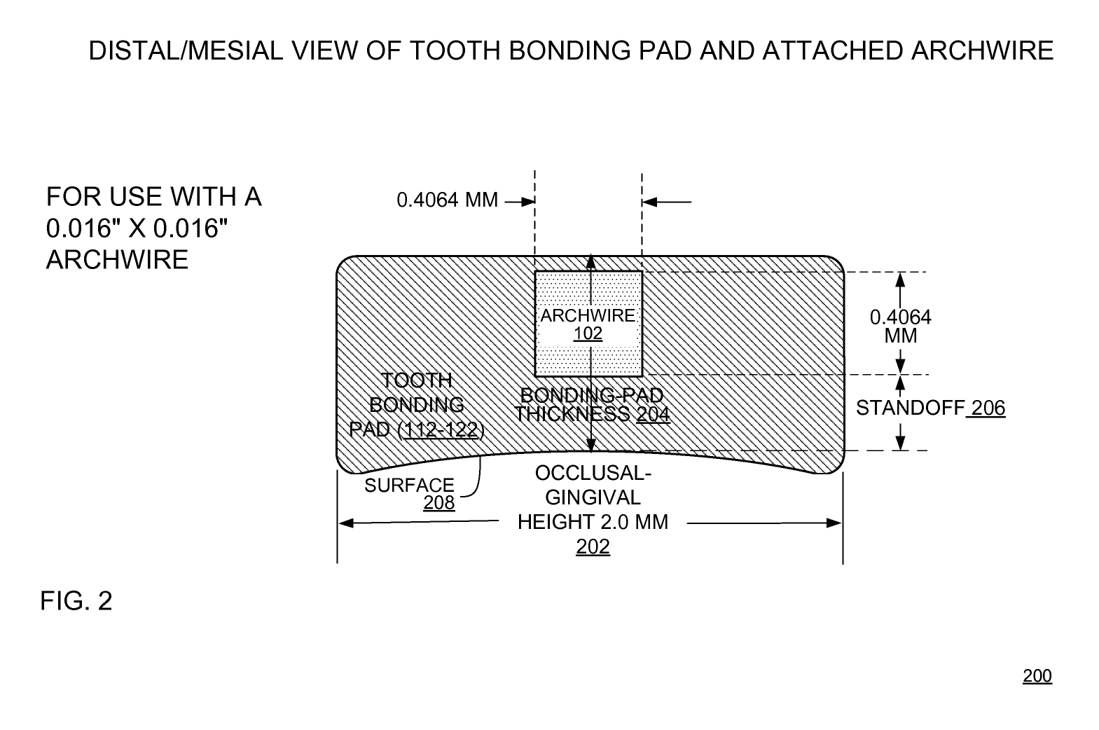

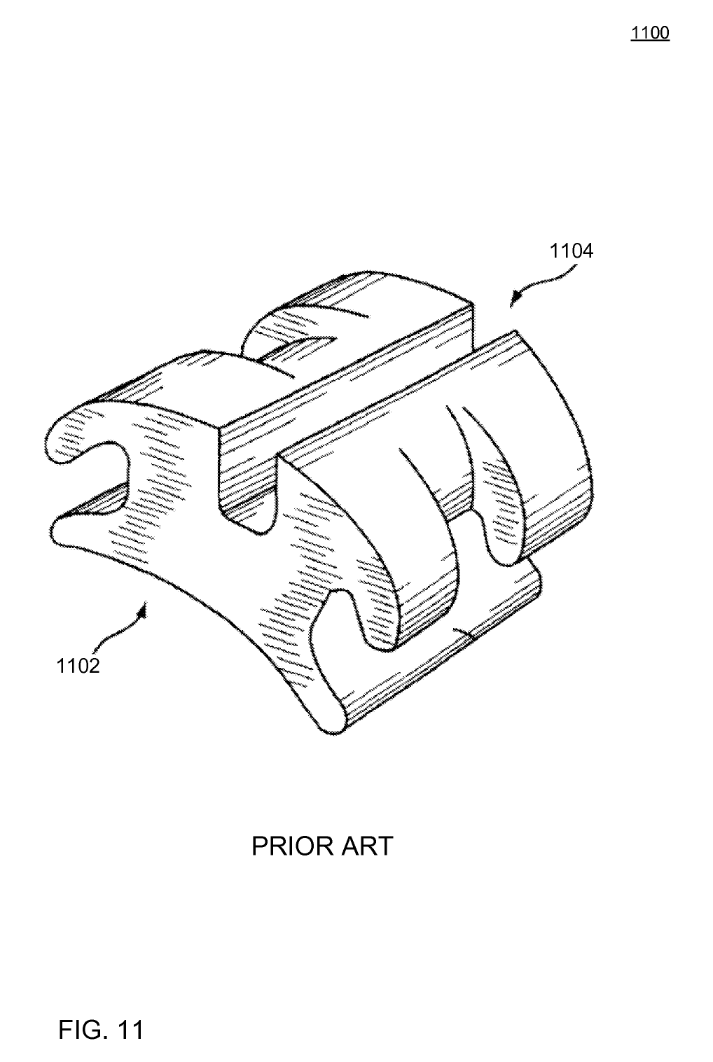

An important feature in some implementations of system 100 is that the system 100 does not have or include an orthodontic bracket, such as shown in FIG. 11. No orthodontic bracket is attached to either the tooth-bonding pads 112-122 or the archwire 102. No orthodontic bracket is between the tooth-bonding pads 112-122 and the archwire 102. The lack of an orthodontic bracket simplifies the fabrication of the system 100. The lack of an orthodontic bracket also improves the comfort of a patient to which the system 100 is applied. The absence of an orthodontic bracket provides a lower physical profile and a smaller height dimension, as shown in FIG. 2. The lower physical profile of system 100 positions the archwire 102 further away from the inside of the cheek of the patient to which the system 100 is applied, thus reducing friction of the inside of the cheek on the archwire 102, and thus improving comfort of the patient to which the system 100 is applied.

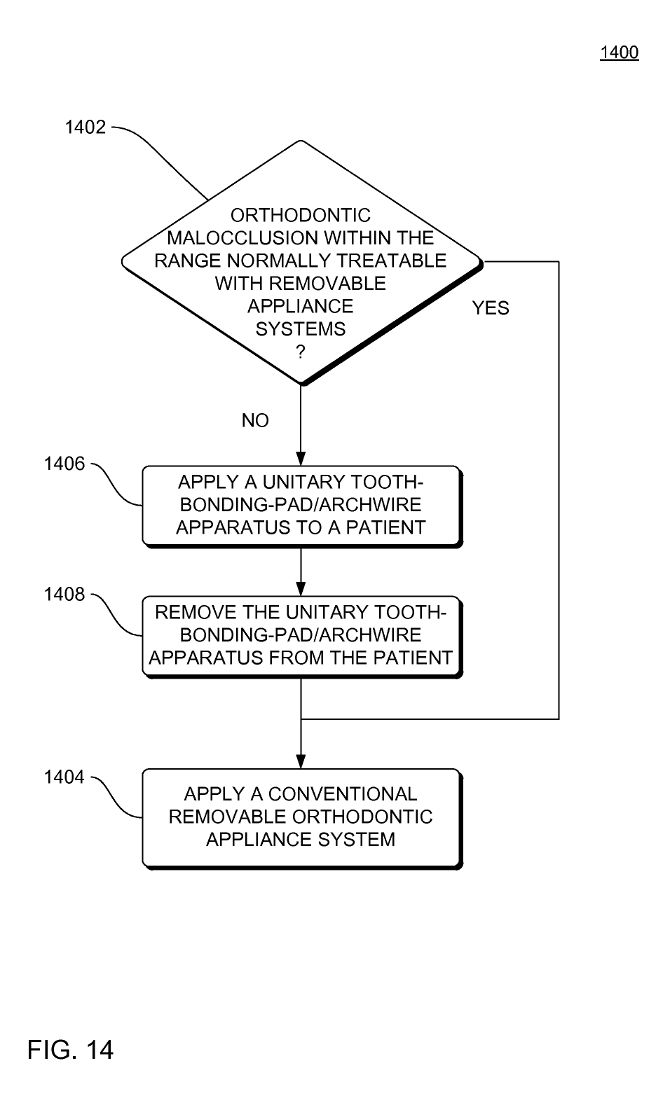

System 100 can be implemented as an enabling appliance for orthodontic patients who, without prior treatment using system 100, would not be practical candidates for complete and finishing orthodontic treatment with other removable orthodontic appliance systems, as described in greater detail in FIG. 14 below.

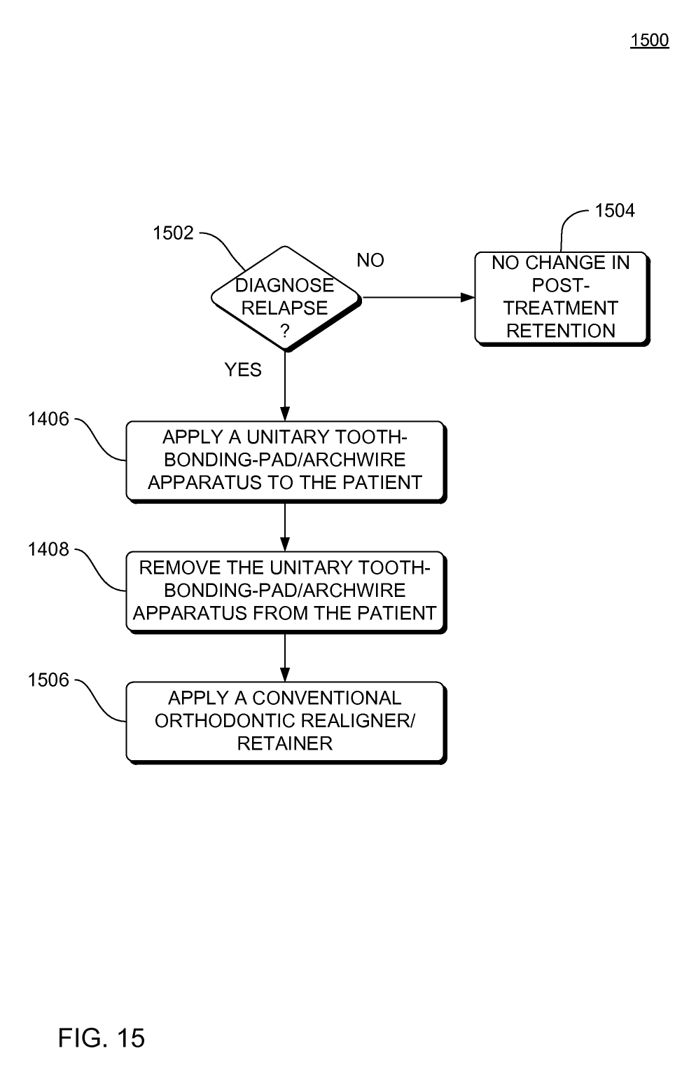

For correction of orthodontic relapse, where the degree of relapse is outside the range of treatment of a conventional realigner-retainer appliance, system 100 is implemented to bring the degree of correction needed back within range of a realigner or a retainer, as described in greater detail in FIG. 15.

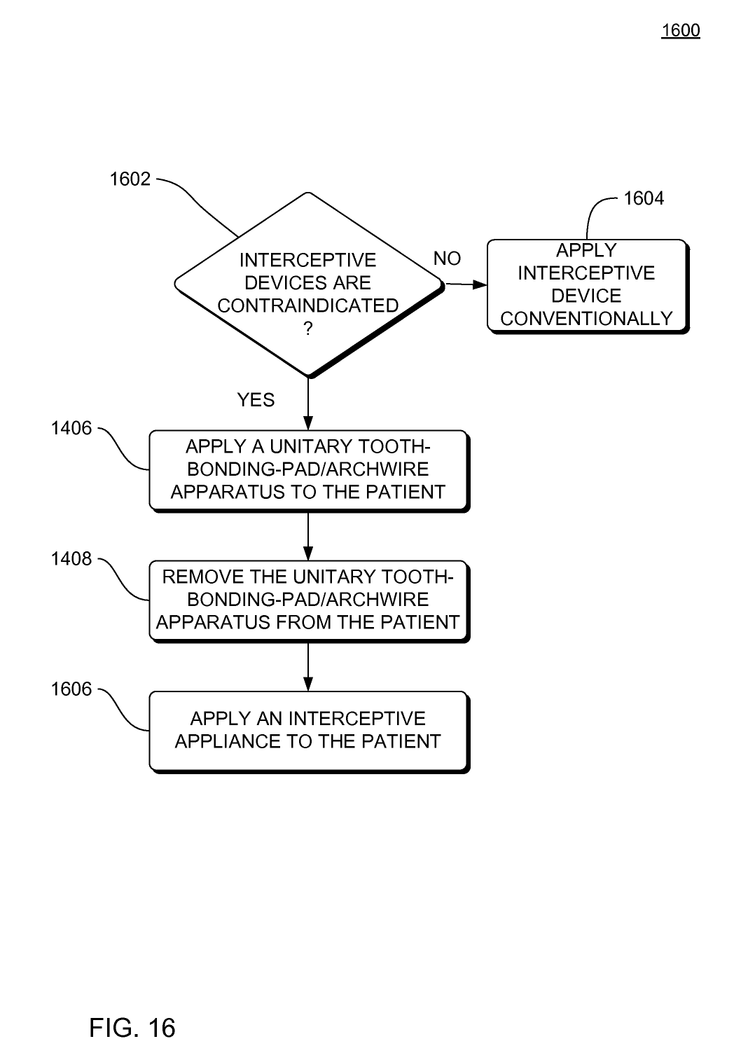

System 100 can be implemented in order to facilitate the implementation of interceptive removable orthodontic devices for patients in a mixed dentition age range. For patients who have one or more teeth positioned such that the implementation of interceptive devices would be contraindicated, these problematically positioned teeth can be moved into positions by system 100 in which the positions permit the implementation of these interceptive appliances. Interceptive orthodontic appliances include Frankel orthodontic appliances, Schwarz orthodontic appliances and Bionator orthodontic appliances, as described in greater detail in FIG. 16.

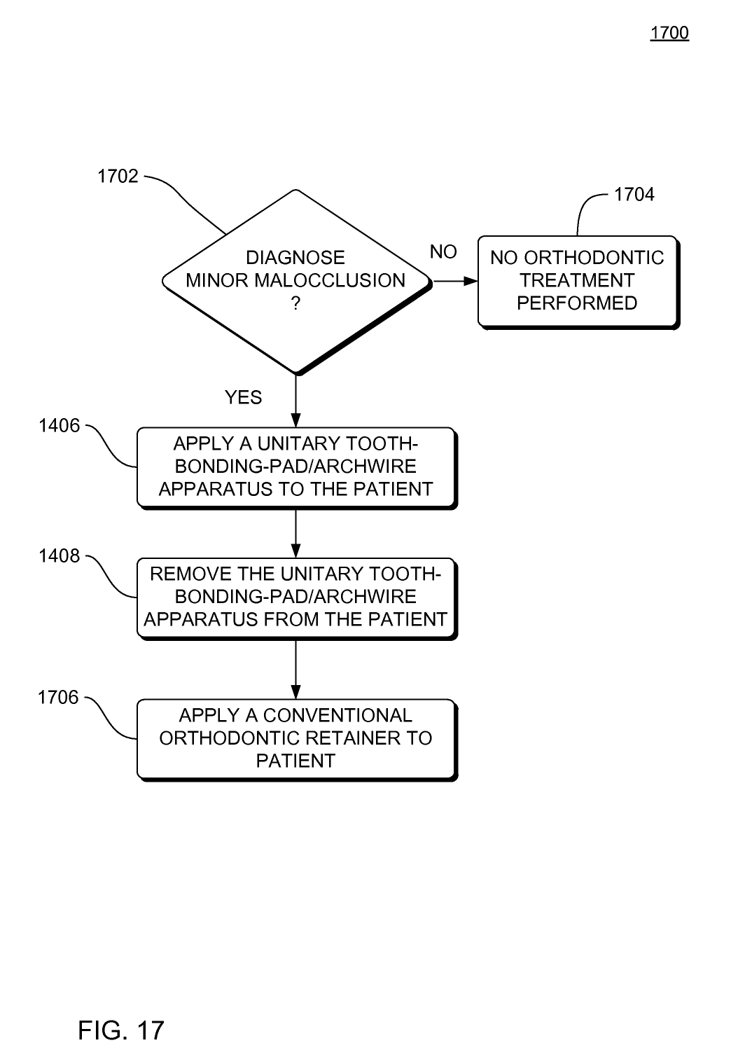

In addition system 100 can be implemented as a single appliance treatment for complete orthodontic treatment in cases of minor orthodontic malocclusions. For example, in cases where a dental malocclusion consists of only minor tooth displacements, such as buccal-lingual displacements, rotations, tipping, and vertical height discrepancies, complete orthodontic treatment can be obtained with the application of system 100. Following completion of orthodontic treatment using system 100, any conventional retainer, such as a Hawley orthodontic appliance can be implemented to retain the orthodontic result, as described in greater detail in FIG. 17.

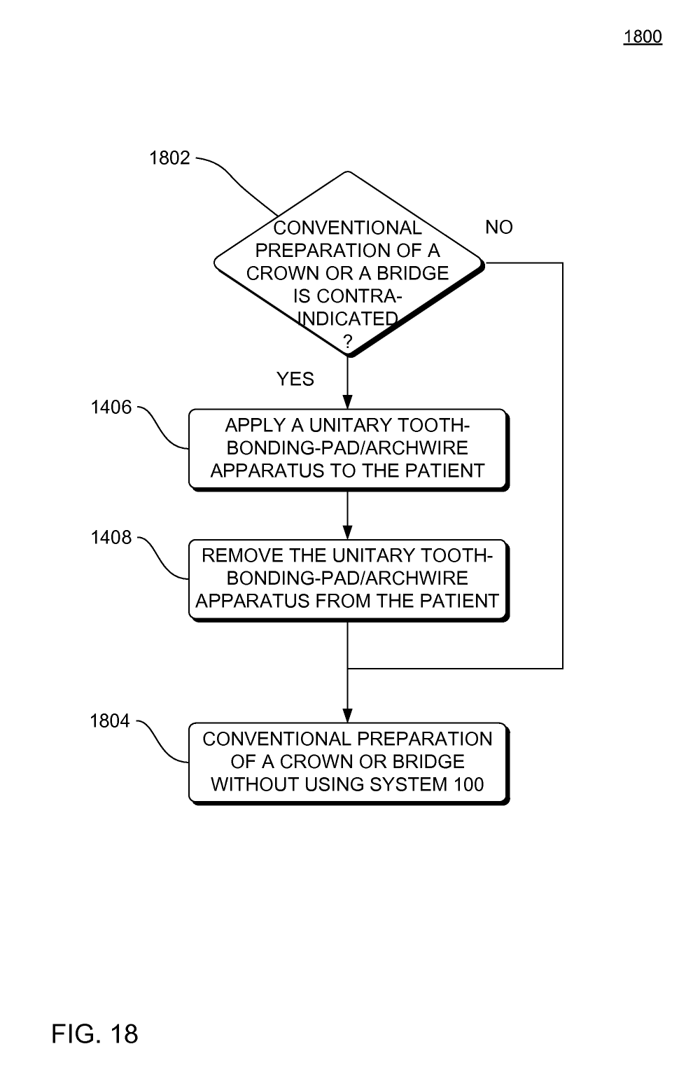

System 100 can be implemented prior to crown and bridge work in dentistry. When one or more of teeth that are to be prepared for crowns or as abutments for bridgework are in less than ideal positions, system 100 can be implemented to better position these teeth for stress bearing associated with chewing forces, and also to allow for a more aesthetically appearing cosmetic result. Short term correction involving system 100 aligns the anterior teeth so that conservative crown preparation will allow for a cosmetically ideal result, as described in greater detail in FIG. 18.

In some implementations of system 100, the materials of the archwire 102 and/or the tooth-bonding-pads 112-122 include 0.0-5.5% iron, 7.0 to 9.0% aluminum, 3.0-5.5% nickel, 1.0-8.0% zinc, 0-2.5% manganese and the remainder being copper, or any other material that will work with conventional approved orthodontic bonding systems implemented for orthodontic bracket placement. The geometry of the tooth-bonding-pads 112-122 are of standardized bracket base form, derived from statistical tooth geometry data for labial and buccal tooth surfaces.

In the implementation shown in FIG. 1, the system 100 includes 6 tooth-bonding-pads 112-122. However, other implementations can be fabricated, with any number of tooth-bonding-pads, such as 10 tooth-bonding-pads, 11 tooth-bonding-pads, 12 tooth-bonding-pads, 13 tooth-bonding-pads, 15 tooth-bonding-pads or 16 tooth-bonding-pads. The disclosure herein is not limited by the number of tooth-bonding-pads.

The locations for the tooth-bonding-pads 112-122 on the archwire 102 in FIG. 1 is one implementation. Variation among population bases and future applications associated with evolving treatment modalities alter the exact location of these tooth-bonding-pads 112-122 on the archwire 102. Additionally, the archwire 102 and tooth-bonding-pads 112-122 can be custom fabricated for a selected patient based on full arch impressions, optical or infrared scans, or calibrated photography, thus many variations in the locations for the tooth-bonding-pads 112-122 on the archwire 102 are contemplated.

In some implementations, the contours of the tooth-bonding-pads 112-122 are in accordance with existing statistical norms of the labial and buccal surfaces of the teeth. The size of the tooth-bonding-pads 112-122 are varied slightly to allow for the different force per unit deflection of the different diameter archwires.

In some implementations of system 100, each of the tooth-bonding-pads have an orientation to the archwire 102 such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In further implementations, the tooth-bonding-pads are accurately appositioned with labial and buccal aspects at occlusal-gingival center and mesial-distal center to the extent that the human teeth that are not in orthodontically correct positions will experience corrective orthodontic forces moving the human teeth toward orthodontically correct positions.

In some implementations of system 100, each of the tooth-bonding-pads includes at least one contour of each of the tooth-bonding-pads being produced from existing statistical norms of the labial and buccal surfaces of the teeth.

In some implementations of system 100, the archwire 102 includes a nickel-titanium (NiTi) alloy metal. In some implementations of system 100, the archwire 102 includes a thermally activated nickel-titanium (NiTi) alloy metal. In some implementations of the thermally activated NiTi alloy, force activation occurs at approximately 27 degrees Celsius and approximately 81 degrees Fahrenheit. Other metals that the archwire 102 can be made of include beta-Titantium, beta-Titantium-nickel, Titantium-carbide, Titanium Molybdenum alloys, stainless steel and/or nickel-cobalt alloys. In some implementations of system 100, the archwire 102 includes stainless steel. In some implementations of system 100, the archwire 102 includes gold. In some implementations of system 100, the archwire 102 includes ceramic coated nickel titanium and stainless steel.

In some implementations of system 100, the archwire 102 includes a diameter selected from the group of diameters consisting of 0.012 inches round, 0.014 inches round, 0.016 inches round, and 0.016×0.016 inches rectangular cross section.

In some implementations of system 100, the archwire 102 includes a tooth-color as a result of manufacturing with epoxy coatings or other tooth-colored surfaces. Tooth-bonding-pads 112, 114, 116, 118, 120 and 122 can be removeably attached to any surface of a tooth.

While the system 100 is not limited to any particular archwire 102 and tooth-bonding-pads 112-122, for sake of clarity a simplified archwire 102 and tooth-bonding-pads 112-122 are described.

The fixed dimensions between the centers of tooth-bonding-pads 112 and 114 is about 7.15 mm, the fixed dimensions between the centers of tooth-bonding-pads 114 and 116 is about 7.6 mm, the fixed dimensions between the centers of tooth-bonding-pads 116 and 118 is about 8.5 mm, the fixed dimensions between the centers of tooth-bonding-pads 118 and 120 is about 7.6 mm, and the fixed dimensions between the centers of tooth-bonding-pads 120 and 122 is about 7.15 mm.

In some implementations, the archwire 102 includes two sides 124 and 126. In the implementation illustrated in FIG. 1, each side 124 and 126, is symmetrical. The geometry and the dimensions of the archwire 102 and the tooth-bonding-pads 112-122 are symmetrical between the two sides 124 and 126, and also the positions of the tooth-bonding-pads 112-122 on the archwire 102 are symmetrical between the two sides 124 and 126. Other implementations of system 100 that are not illustrated herein are asymmetrical in one or more aspects.

In some implementations tooth-bonding-pads 112 and 122 for the canine teeth have a thinner thickness than the thickness for the tooth-bonding-pads in the close vicinity, such as tooth-bonding-pads 114 and 120 because in some patients, the first buccal surfaces of the canine teeth is more pronounced or more protruding than the first buccal surfaces of the adjacent teeth.

### Apparatus Implementations

In the previous section, a system level overview of an implementation was described. In this section, particular apparatus of such an implementation are described by reference to a series of diagrams. The dimensions cited herein, of the distal-mesial length and the occlusal-gingival height, are merely illustrative and not limiting. In the apparatus implementations, the notation “tooth-bonding-pads 112-122” refers to any of the tooth-bonding-pads 112, 114, 116, 118, 120 or 122.

FIG. 2 is a distal or mesial view of a cross section block diagram of a device 200 according to an implementation illustrating an archwire exiting or protruding from an interior of a tooth-bonding-pad.

Device 200 is a unitary tooth-bonding-pad/archwire device that does not have or include an orthodontic bracket, which as a result of the absent orthodontic bracket, can be fabricated easily, simply and inexpensively, and that has a low physical profile and a smaller height dimension that positions the archwire 102 further away from the inside of the cheek of a patient to which the device 200 is applied, thus reducing friction on the inside of the cheek on the archwire 102, and thus improving comfort of the patient to which the device 200 is applied.

In device 200, the archwire 102 has a diameter of 0.4064 mm that passes through a tooth-bonding-pad. The tooth-bonding-pad in device 200 is any one of the tooth-bonding-pads 112-122 shown in FIG. 1.

As shown in FIG. 2, most of the outside surface of the archwire 102 of device 200 is fabricated into the tooth-bonding-pads 112-122. The archwire 102 is encompassed within tooth-bonding-pads 112-122. The achwire 102 is directly attached to the tooth-bonding-pad 112-122 through a bonding agent. In the implementation shown in FIG. 2, about 100% (4 of 4 surfaces) of the outside surface in close proximity to the archwire 102 of device 200 is fabricated into the tooth-bonding-pads 112-122. In some implementations of device 200, the outside surface of the archwire 102 is fabricated into the tooth-bonding-pads 112-122. In some implementations of device 200, the archwire 102 is permanently fabricated into the interior of the matter of the tooth-bonding-pad.

Some implementations, a surface 208 of the tooth-bonding-pad 112-122 that can contact a tooth is microetched by a chemical process to condition the tooth-bonding-pad for better adhesion to a tooth or have a mesh thin screen wire attached or otherwise laminated to the tooth-bonding-pad.

In the implementation shown in FIG. 2-4, the tooth-bonding-pad 112-122 has an occlusal-gingival height 202 in a range of 0.1 mm to 3.0 mm, a tooth-bonding pad thickness 204 in a range of 0.10 mm to 2.0 mm and a standoff 206 in the range of 0.10 mm to 2.0 mm.

The absence of an orthodontic bracket in device 200 provides a lower profile and a smaller standoff 206. The smaller standoff 206 of device 200 positions the archwire 102 closer to the gingival and thus further away from the inside of the cheek of the patient, thus reducing friction between the inside of the cheek and the archwire 102, and therefore improving comfort of the patient.

Device 200 is not limited to any particular dimensions of the archwire 102, tooth-bonding-pads 112-122, occlusal-gingival height 202, tooth-bonding-pad thickness 204, standoff 206 or the mesial-distal length 302.

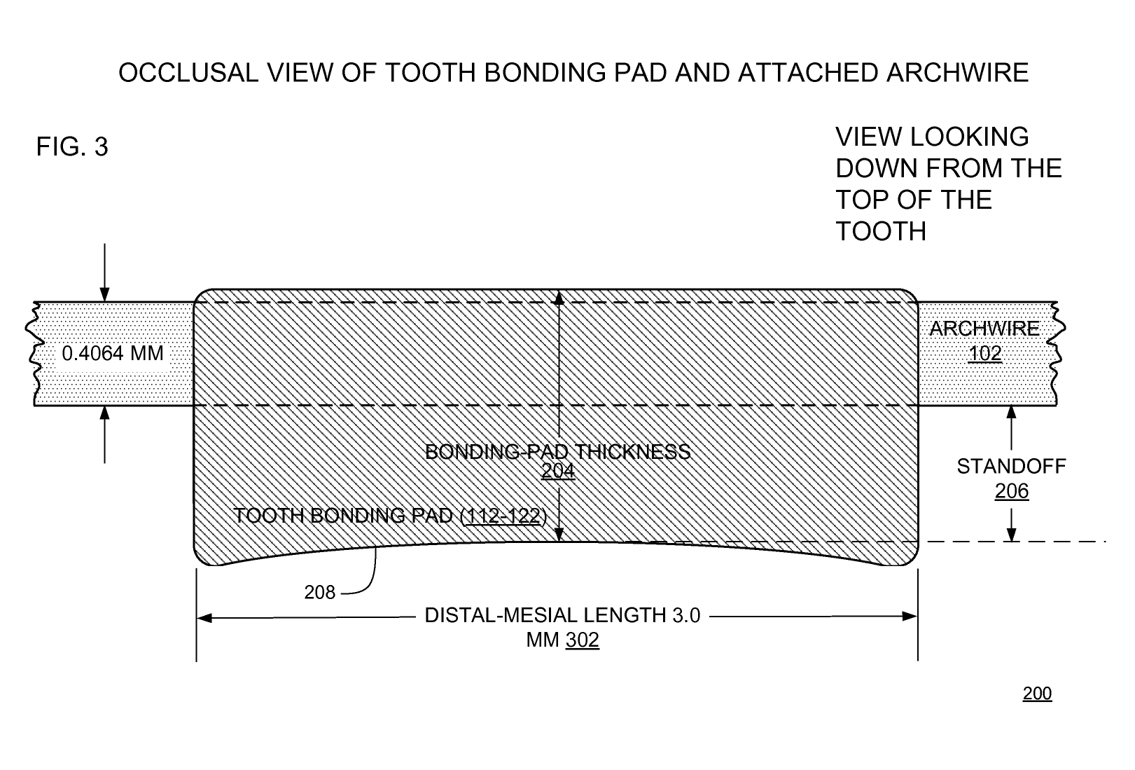

FIG. 3 is an occlusal view of a cross section block diagram of device 200 according to an implementation illustrating an archwire exiting or protruding from an interior of a tooth-bonding-pad.

The archwire 102 extends through the interior of the matter of the tooth-bonding-pad 112-122 as shown in FIG. 3. In device 200, the archwire 102 passes through the tooth-bonding-pad 112-122 as shown in FIG. 3. The mesial-distal length 302 in device 200 can range from 1.5 mm to 3.5 mm.

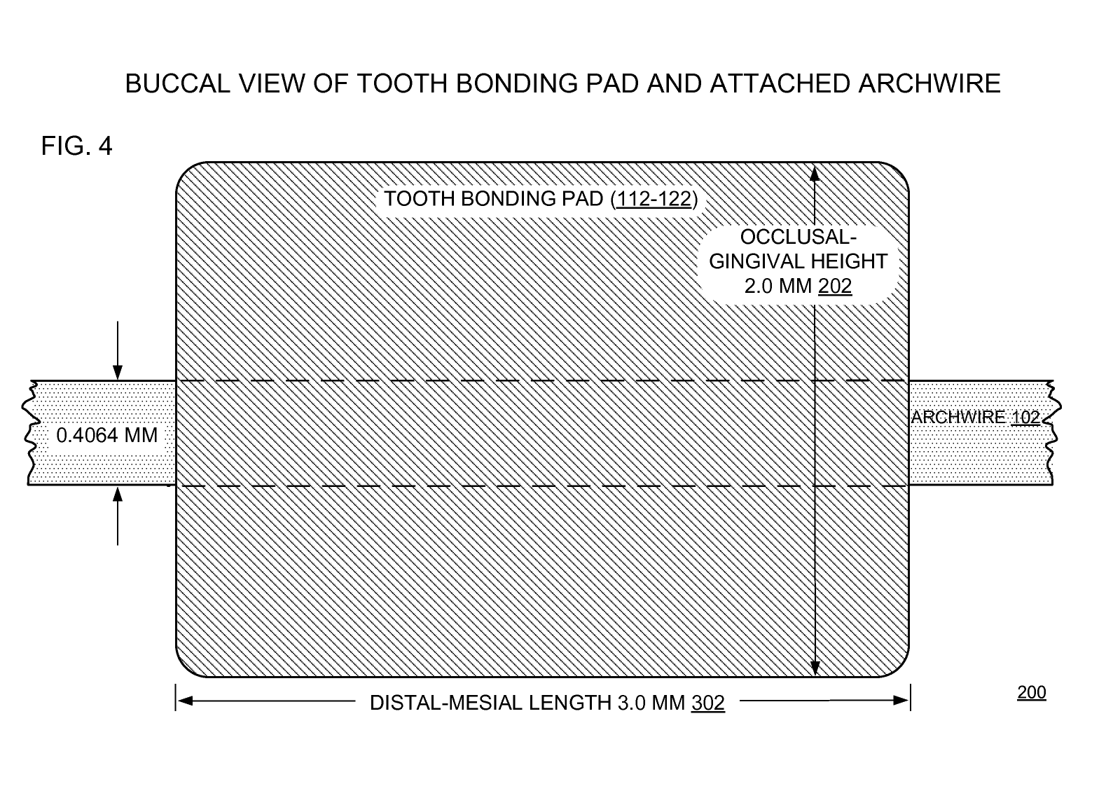

FIG. 4 is a buccal view of a cross section block diagram of the device 200 according to an implementation illustrating an archwire exiting or protruding from an interior of a tooth-bonding-pad.

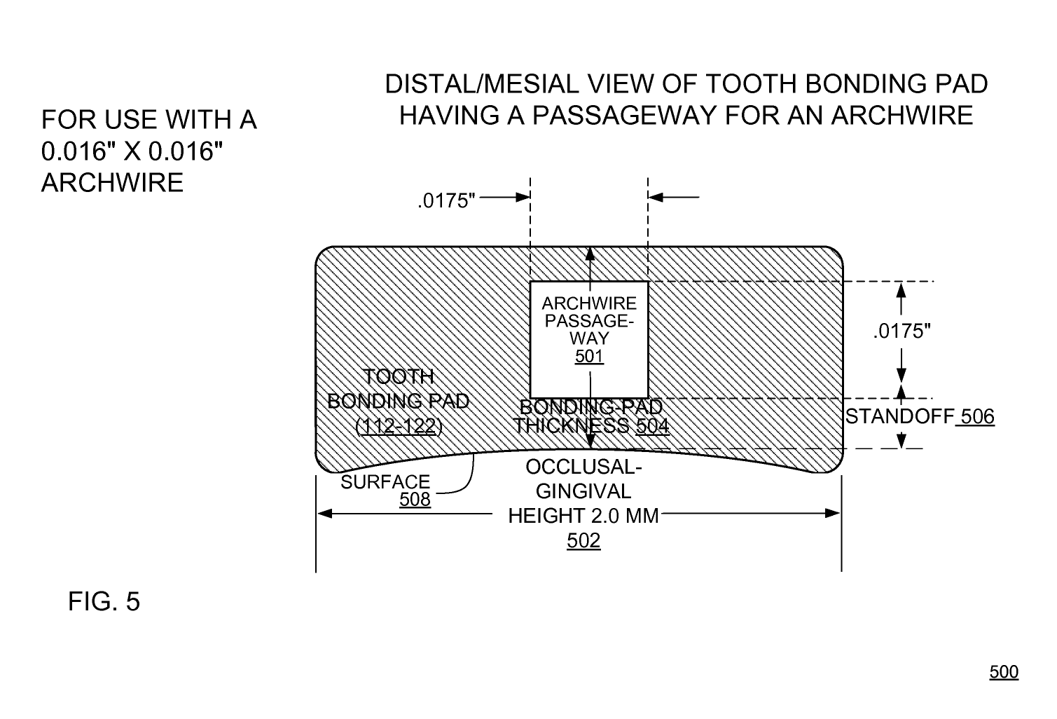

FIG. 5 is a distal or mesial view of a cross section block diagram of a device 500 according to an implementation illustrating an archwire passageway in an interior of a tooth-bonding-pad.

Device 500 is a unitary tooth-bonding-pad/archwire device that does not have or include an orthodontic bracket, which as a result of the absent orthodontic bracket, can be fabricated easily, simply and inexpensively, and that has a low physical profile and a smaller height dimension that positions the archwire 102 via the archwire passageway 501 further away from the inside of the cheek of a patient to which the device 500 is applied, thus reducing friction on the inside of the cheek on the archwire 102 via the archwaire passageway 501, and thus improving comfort of the patient to which the device 500 is applied.

In device 500, the archwire passageway 501 has a diameter of 0.1075 inches that passes through a tooth-bonding-pad. The tooth-bonding-pad in device 500 is any one of the tooth-bonding-pads 112-122 shown in FIG. 1.

An archwire 102 can be placed in the archwire passageway 501. The archwire 102 can slide across the inside surfaces of the archwire passageway 501. The achwire 102 is not attached to the tooth-bonding-pad 112-122 through a bonding agent. The archwire 102 is not fabricated into the tooth-bonding-pads 112-122. Neither is the archwire 102 permanently fabricated into the passageway 501 of the tooth-bonding-pad.

Some implementations, a surface 508 of the tooth-bonding-pad 112-122 that can contact a tooth is microetched by a chemical process to condition the tooth-bonding-pad for better adhesion to a tooth or have a mesh thin screen wire attached or otherwise laminated to the tooth-bonding-pad.

In the implementation shown in FIG. 5, the tooth-bonding-pad 112-122 has an occlusal-gingival height 502 in a range of 0.1 mm to 3.0 mm, a tooth-bonding thickness 504 in a range of 0.10 mm to 2.0 mm and a standoff 506 in the range of 0.10 mm to 2.0 mm.

The absence of an orthodontic bracket in device 500 provides a lower profile and a smaller standoff 506. The smaller standoff 506 of device 500 positions the archwire 102 closer to the gingival and thus further away from the inside of the cheek of the patient, thus reducing friction between the inside of the cheek and the archwire 102, and therefore improving comfort of the patient.

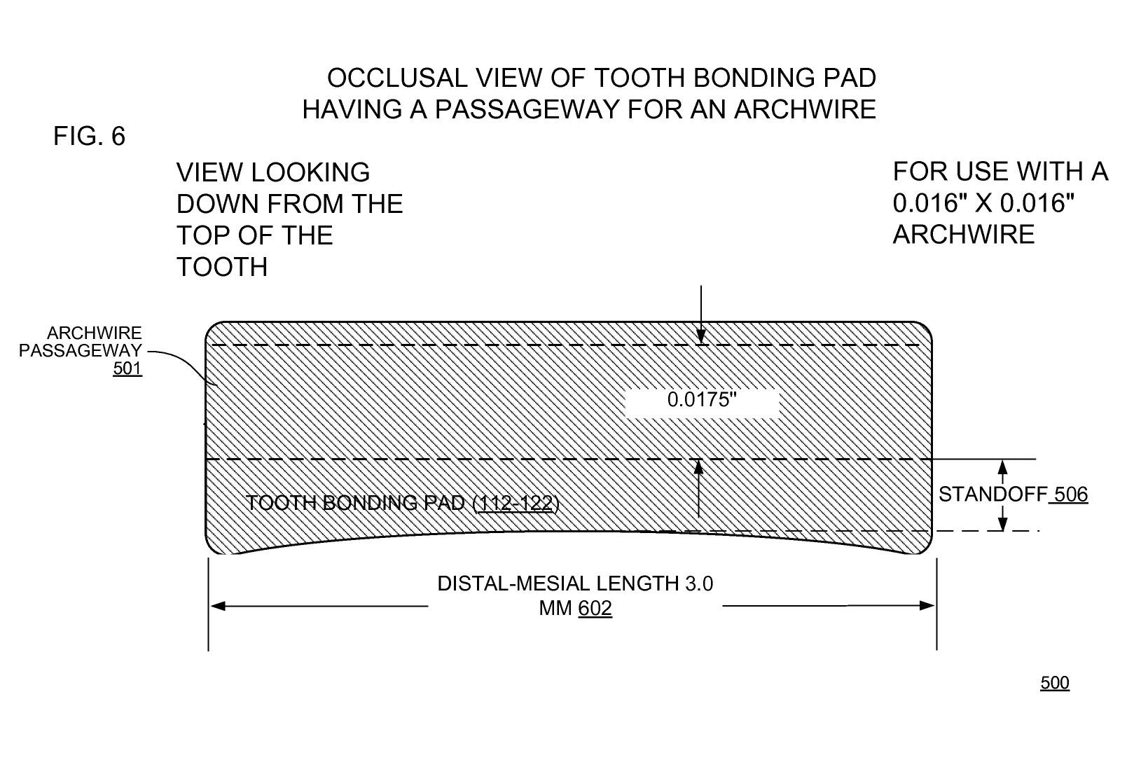

FIG. 6 is an occlusal view of a cross section block diagram of device 500 according to an implementation illustrating an archwire passageway in an interior of a tooth-bonding-pad.

The archwire passageway 501 extends through the interior of the matter of the tooth-bonding-pad 112-122 as shown in FIG. 6. In device 500, an archwire 102 can be slideably positioned in the archwire passageway 501.

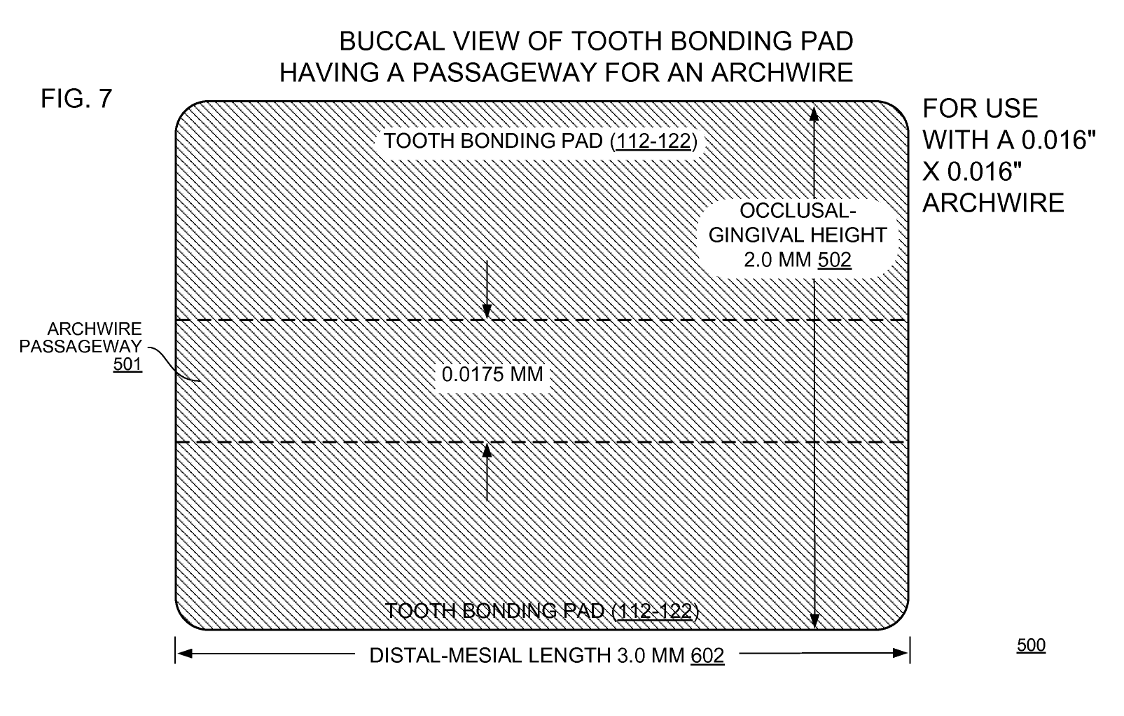

FIG. 7 is a buccal view of a cross section block diagram of device 500 according to an implementation illustrating an archwire passageway in an interior of a tooth-bonding-pad.

Passageway 501 in FIG. 5-7 has an opening at each of the opposite mesial-distal ends of the device 500. The passageway is of uniform geometric proportions from the openings and through the device 500. In all implementations of passageway 501, the passageway 501 is substantially smooth to minimize sliding friction between the device 500 and an archwire. Device 500 in FIG. 5-7 is not limited to any particular dimensions of the archwire passageway 501, occlusal-gingival height 502, tooth-bonding-pad thickness 504, standoff 506, mesial-distal length 602, tooth-bonding-pads 112-122 or the archwire 102.

The archwire 102 is depicted in FIG. 2-7 as being rectangular in cross-section. However, the geometry of the archwire can be any variety of geometries in cross-section, such as round, oval, eliptical, square, pentagular, heptangular, octangular, decangular, or asymmetrical.

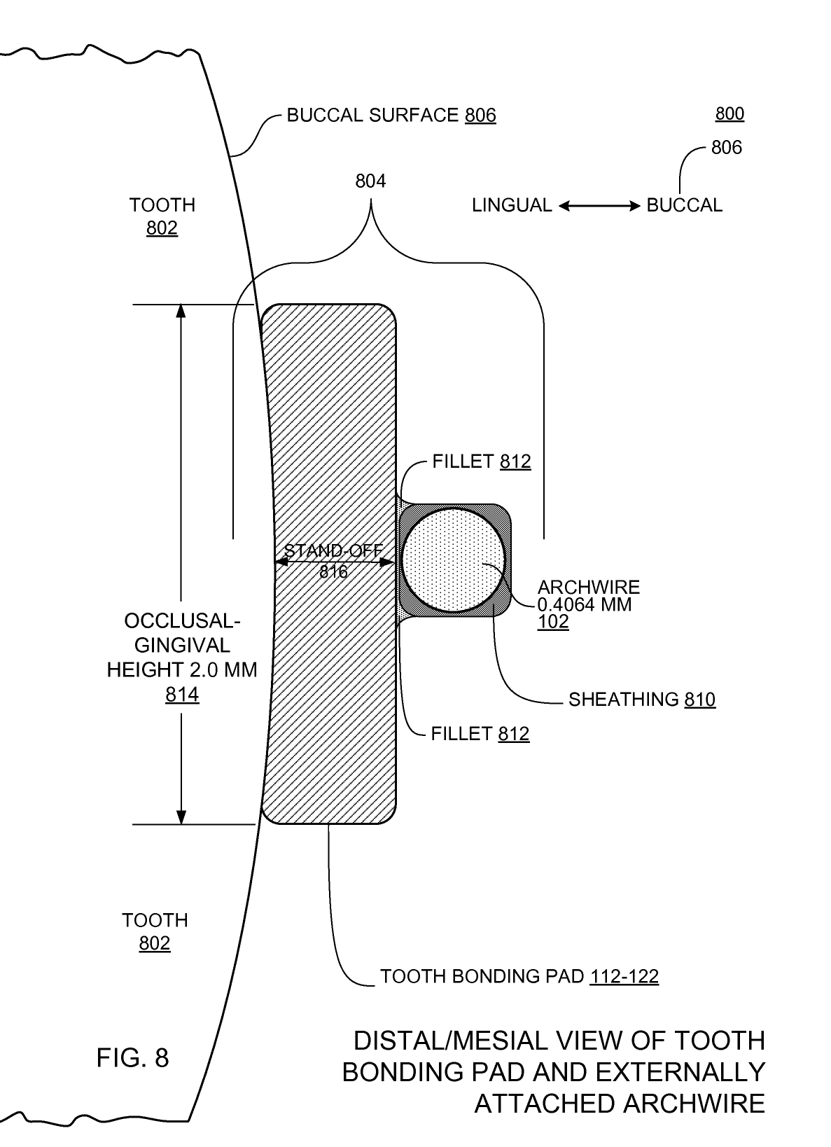

FIG. 8 is a distal-mesial view of a cross section block diagram 800 of a unitary tooth-bonding-pad/archwire device 800 attached externally to a tooth, according to an implementation. FIG. 8 shows a tooth 802. A unitary tooth-bonding-pad/archwire device 806 is applied to the buccal surface 806 of the tooth 802. A unitary tooth-bonding-pad/archwire device 808 includes a toothbonding-pad 112-122 that can be removeably attached to the buccal surface 806 of the tooth 802. A round archwire 102 having a diameter of 0.4064 mm is attached to the tooth-bonding-pad 112-122 through a sheathing 810 to create the unitary tooth-bonding-pad/archwire device 808. In some implementations, the sheathing 810 is a metallic material, such as stainless steel. In some implementations, the attachment between the archwire 102 and the tooth-bondingpad 112-122 includes a fillet 812 of bonding material between the archwire 102 and the sheathing 810. In some implementations, the attachment between the archwire 102 and the tooth bonding pad 112-122 includes bonding material directly between the archwire 102 and the sheathing 810. The occlusal-gingival height 814 of the tooth bonding pad 112-122 is a range of 0.10 to 3.0 mm. A stand-off 816 is in a range of 0.10 mm to 2.0 mm.

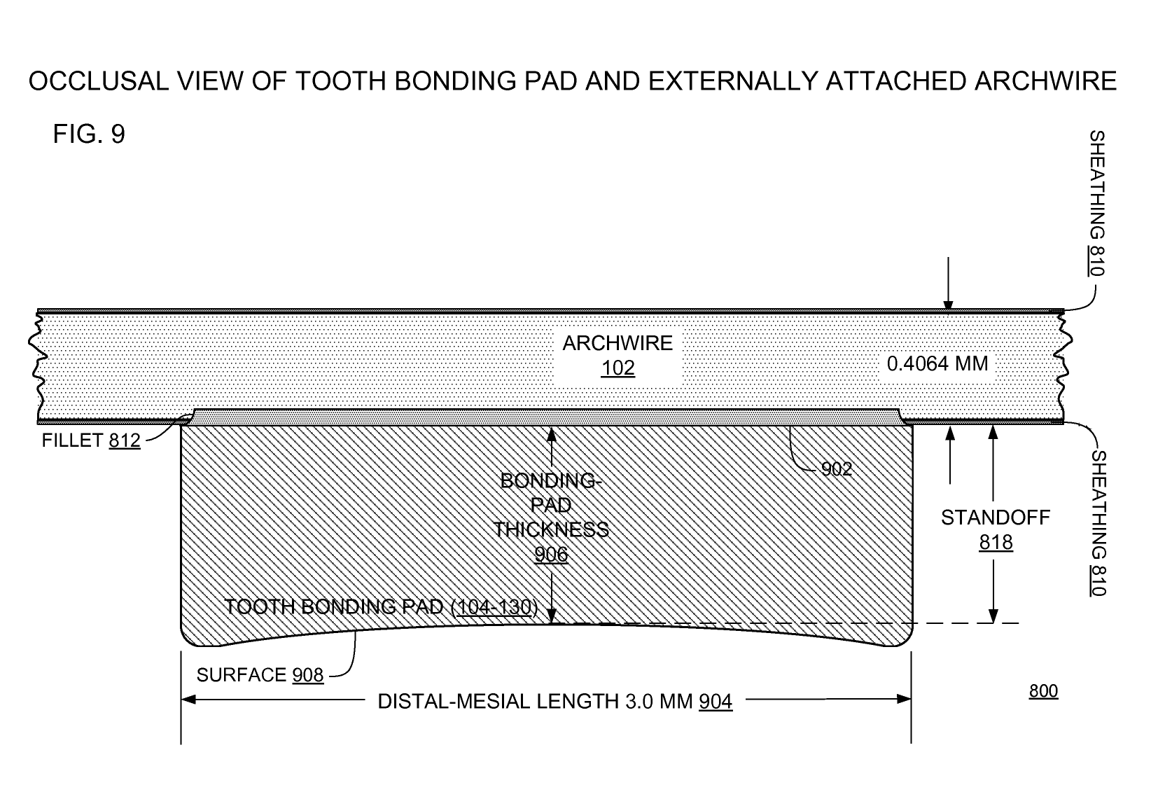

FIG. 9 is an occlusal view of a cross section block diagram of device 800 according to an implementation illustrating an archwire removeably attached to a side of a tooth-bonding-pad. Device 800 is a unitary tooth-bonding-pad/archwire device that does not have or include an orthodontic bracket, which as a result of the absent orthodontic bracket, can be fabricated easily, simply and inexpensively, and that has a low physical profile and a smaller height dimension that positions the archwire 102 further away from the inside of the cheek of a patient to which the device 800 is applied, thus reducing friction of the inside of the cheek on the archwire 102, and thus improving comfort of the patient to which the device 800 is applied.

In device 800, the archwire 102 is fabricated onto the side 902 of the tooth-bonding-pad 112-122. In device 800, less than half of the outside surface of the archwire 102 that is in close proximity to the tooth-bonding-pad 112-122 is fabricated onto the tooth-bonding-pad 112-122. In the implementation shown in device 800 in FIG. 8-10, the tooth-bonding-pad 112-122 includes a standoff 818 in a range of 0.1 mm to 2.0 mm, a mesial-distal length 904 in a range of 1.5 mm to 3.5 mm, and a tooth-bonding-pad thickness 906 in a range of 0.1 mm to 2.0 mm. In device 800, the bonding-pad thickness 906 is equal to the standoff 818. However, the disclosure herein is not limited to any particular dimensions of the standoff 818, mesial-distal length 904, tooth-bonding-pad thickness 906, tooth-bonding-pads 112-122 or the archwire 102.

The absence of an orthodontic bracket in device 800 provides a lower profile and a smaller standoff 906. The smaller standoff 818 and tooth-bonding-pad thickness 906 of device 800 positions the archwire 102 closer to the gingival and thus further away from the inside of the cheek of the patient, thus reducing friction between the inside of the cheek and the archwire 102, and therefore improving comfort of the patient.

Some implementations, a surface 908 of the tooth-bonding-pad 112-122 that can contact a tooth is microetched by a chemical process to condition the tooth-bonding-pad for better adhesion to a tooth or have a mesh thin screen wire attached or otherwise laminated to the tooth-bonding-pad.

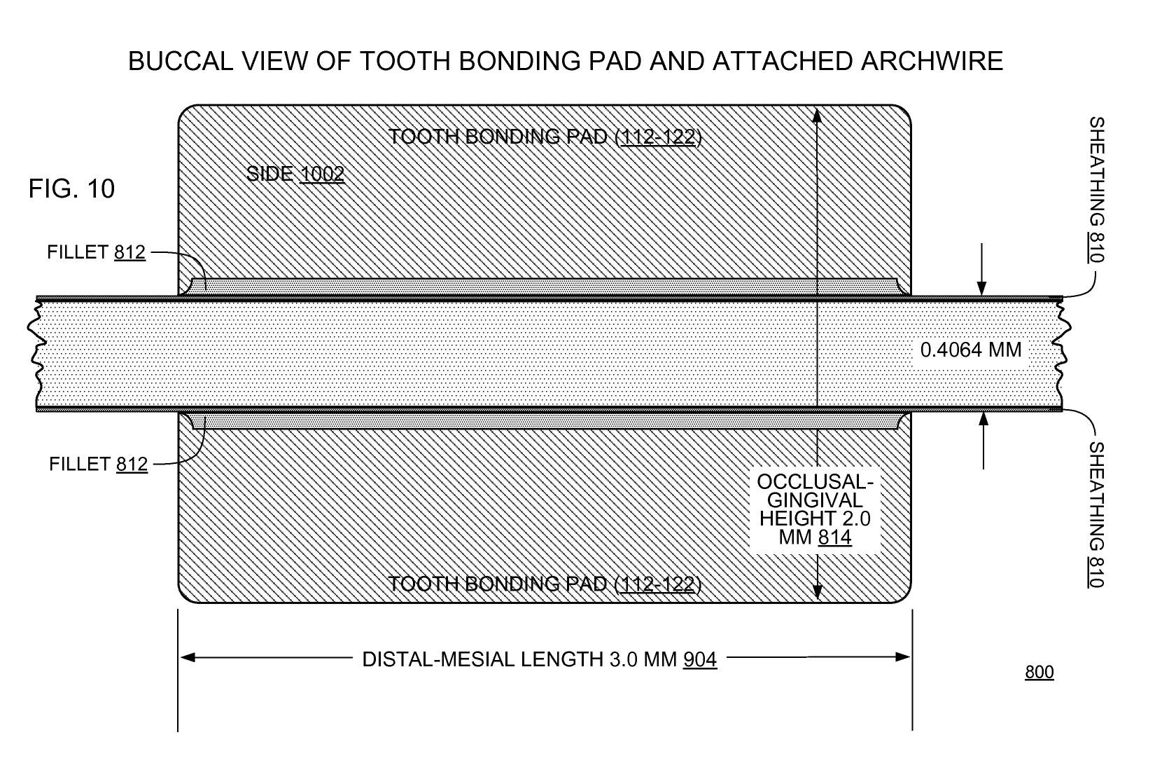

FIG. 10 is a buccal view of a cross section block diagram of device 800 according to an implementation illustrating an archwire removeably attached to a side of a tooth-bonding-pad.

In device 800, less than half of the outside surface of the archwire 102 is fabricated onto the side 1102 of the tooth-bonding-pads 112-122. In the implementation shown in FIG. 10, the tooth-bonding-pad 112-122 includes a mesial-distal length 904 in a range of 1.5 mm to 3.0 mm and an occlusal-gingival height 814 in a range of 0.10 mm to 3.0 mm.

General Comments on Preceding Figures:

The archwire 102 is depicted in FIG. 8-10 as being round in cross-section. However, the geometry of the archwire can be any variety of geometries in cross-section, such as rectangular, oval, eliptical, square, pentagular, heptangular, octangular, decangular, or asymmetrical.

System 100, device 200, device 500 and device 800 do not have or include an orthodontic bracket, which as a result of the absent orthodontic bracket. System 100, device 200, device 500 and device 800 can be fabricated easily, simply and inexpensively, and system 100, device 200, device 500 and device 800 have a low physical profile and a smaller height dimension that positions the archwire 102 further away from the inside of the cheek of the patient, thus reducing friction of the inside of the cheek on the archwire 102, and thus improving comfort of the patient.

FIGS. 2-3, 5-6 and 8-9 show a curved surface onto which the tooth-bonding-pad can adhere to the curved surface of the tooth. The geometry of the curved surface in FIGS. 2-3, 5-6 and 8-9 is merely illustrative, and not necessarily exemplary and not limiting because surfaces of other geometries are within contemplation to accommodate tooth surface curvature geometries of a large variety.

All of the tooth-bonding pads 112-122 in FIG. 1-10 have rounded corners, on corners adjoining the buccal surfaces, the labial surfaces, the mesial surfaces, the distal surfaces, the occlusal surfaces and the gingival surfaces. The rounded corners are clearly illustrated in FIG. 1-10, but other implementations having rounded corners of different radii than shown in FIG. 1-10 are contemplated, and other implementations having square corners are also contemplated.

Prior Art Apparatus:

FIG. 11 is isometric view of a prior art example of a conventional orthodontic bracket 1100 that is not included in system 100, device 200, device 500 and device 800. The bracket 1100 includes a base 1102 having a rear bonding surface 1104 that can be bonded to the buccal surface of a tooth.

### Method Implementations

In the previous section, implementations of apparatus are described. In this section, particular methods of such those implementations are described by reference to a series of flowcharts.

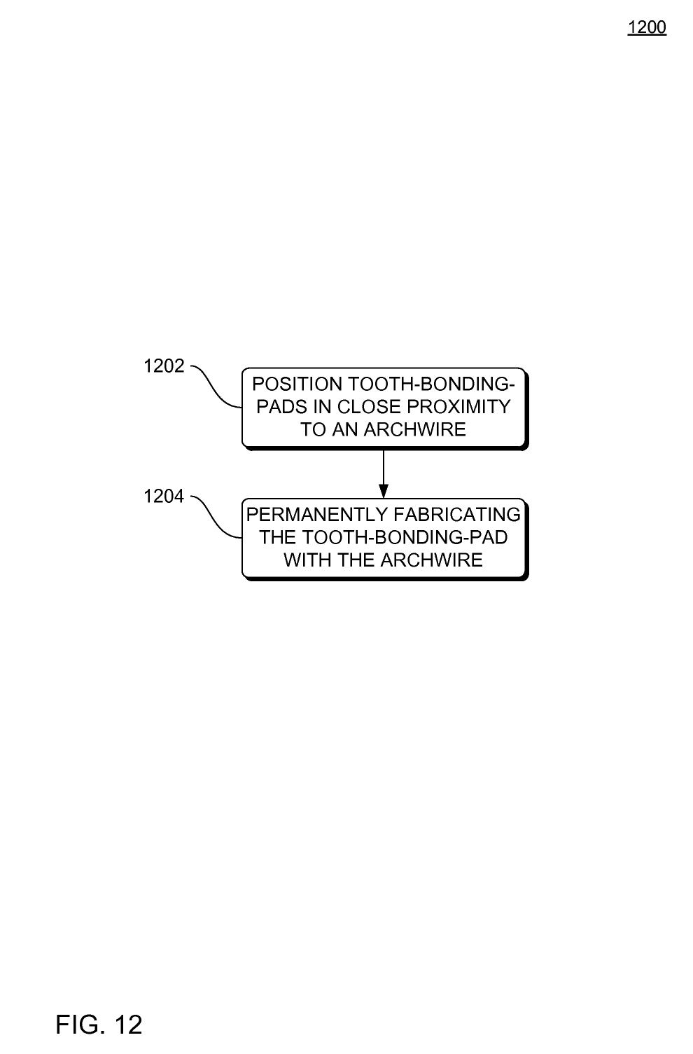

FIG. 12 is a flowchart of a method 1200 to fabricate a unitary tooth-bonding-pad/archwire device, according to an implementation. In method 1200, at least one tooth-bonding-pad and an archwire are transformed into a unitary tooth-bonding-pad/archwire device, such as system 100, device 200, device 500 and device 800.

Method 1200 includes positioning one or more tooth-bonding-pads in close proximity to an archwire at fixed positions of the archwire, at block 1202. One example of the tooth-bonding-pads are tooth-bonding-pads 112-122 in FIG. 1. One example of the archwire is archwire 102 in FIG. 1.

Method 1200 includes permanently fabricating the one or more tooth-bonding-pads with the archwire at fixed positions of the archwire, at block 1204.

In one implementation of permanently fabricating 1204 one or more tooth-bonding-pads with the archwire at fixed positions of the archwire, each of the plurality of tooth-bonding-pads is metallurgically permanently fabricated into the archwire at fixed positions of the archwire.

In one implementation of permanently fabricating one or more tooth-bonding-pads with an archwire at fixed positions of the archwire 1204, each of the plurality of tooth-bonding-pads (e.g. 112-122 in FIG. 1) are formed as one complete integral unit with the archwire (e.g. 102 in FIG. 1). Forming the tooth-bonding-pads as one complete integral unit with the archwire is performed in one implementation by casting or vacuum casting a melted metal into molds of magnesia and silica by a dental argon-arc pressure casting machine with a copper crucible, or by an argon arc centrifugal casting machine, or by an arc-melting gas pressure casting machine. One example of a dental argon-arc pressure casting machine is the AX-AWM1 dental argon-arc pressure casting machine manufactured by Tianjin Aixin Medical Equipment Co., Ltd in Tainjin, China 300308. One example of an argon arc centrifugal casting machine is an argon arc centrifugal casting machine manufactured by O'Hara Co., Ltd of Osaka, Japan. One example of an arc-melting gas pressure casting machine is the AX-AWMAX1 arc-melting gas pressure casting machine manufactured by Tianjin Aixin Medical Equipment Co., Ltd in Tainjin, China 300308.

In one implementation of permanently fabricating one or more tooth-bonding-pads with the archwire at fixed positions on the archwire 1204, each of the plurality of tooth-bonding-pads (e.g. 112-122 in FIG. 1) are permanently fabricated to the archwire (e.g. archwire 102 in FIG. 1) through a welding/brazing process that is appropriate for the materials of the archwire and the tooth-bonding-pad(s). For example the tooth-bonding-pads are permanently fabricated to the archwire by sintering, laser welding, electrical resistance welding, tungsten inert gas welding or brazing/soldering. In some implementations of laser welding, crystals of yttrium, aluminum, garnet and neodymium emit laser beams. In some implementations of laser welding, gold alloys are laser welded to a cobalt-chromium alloy. In some implementations of tungsten inert gas welding, welding heat is produced by a light bow between tungsten anode and metal. In some implementations of brazing/soldering, the brazing/soldering is performed at more than 450 degrees C.

In one implementation of permanently fabricating one or more tooth-bonding-pads with the archwire at fixed positions of the archwire, each of the plurality of tooth-bonding-pads (e.g. 112-122 in FIG. 1) are permanently fabricated to the archwire (e.g. archwire 102 in FIG. 1) by welding.

In one implementation of permanently fabricating one or more tooth-bonding-pads with the archwire at fixed positions of the archwire 1204, each of the plurality of tooth-bonding-pads is glued onto the archwire at fixed positions of the archwire.

In one implementation of permanently fabricating 1204 one or more tooth-bonding-pads at fixed positions of the archwire, each of the plurality of tooth-bonding-pads is crimped onto the archwire at fixed positions of the archwire.

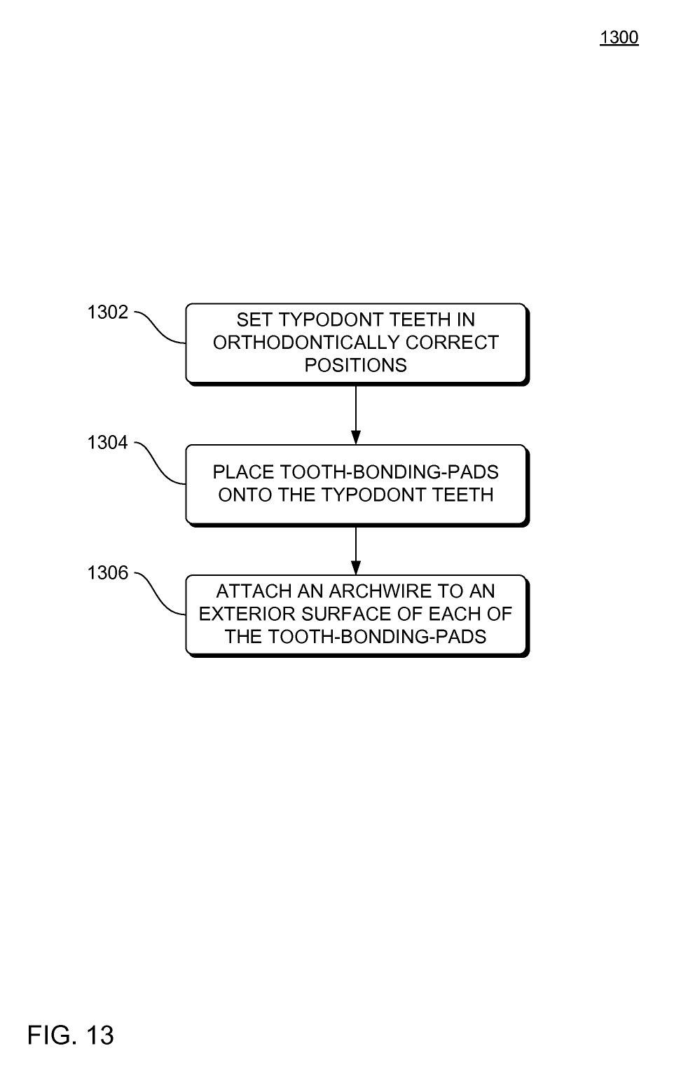

FIG. 13 is a flowchart of a method 1300 to fabricate a unitary tooth-bonding-pad/archwire device, according to an implementation. In method 1300, at least one tooth-bonding-pad and an archwire are transformed into a unitary tooth-bonding-pad/archwire device, such as system 100, device 200 and device 500.

Method 1300 includes setting anatomically correct typodont teeth in orthodontically correct positions, at block 1302. Thereafter, anatomically contoured tooth-bonding-pads are placed onto labial or buccal surfaces of the typodont teeth in the occlusal-gingival center and mesial-distal center of the labial and buccal surface of orthodontically correct positions, at block 1304.

Method 1300 also includes attaching the archwire in an occlusal plane, passively contacting an exterior surface of each of the plurality of tooth-bonding-pads, and rigidly attaching the archwire to a midpoint of each of the corresponding plurality of tooth-bonding-pads, at block 1306.

FIG. 11 is a flowchart of a method 1100 to implement a unitary tooth- bonding-pad/archwire device, according to an implementation before application of removable orthodontic appliance systems. Method 1100 provides effective treatment for orthodontic patients who are not originally practical candidates for removable orthodontic appliance systems.

At block 1102, if orthodontic malocclusion that is within the range that is conventionally diagnosed as treatable with removable applicant systems, then conventional treatment such as applying a conventional removable orthodontic appliance system to treat the malocclusion is performed at block 1104. However, if orthodontic malocclusion is outside of the range that is conventionally diagnosed as treatable with removable applicant systems, then at block 1106 in method 1100, an appropriately selected implementation of system 100 is applied to a patient as an enabling appliance for orthodontic patients who, without prior treatment using system 100, would not be practical candidates for complete and finishing orthodontic treatment with other removable orthodontic appliance systems. Some orthodontic patients who are not practical candidates for removable orthodontic appliance systems have less severe dental malocclusions and/or relapse of prior complete orthodontic treatment. Specifically, there are many cases of orthodontic malocclusion which cannot be fully treated with Invisalign® removable teeth aligner appliances alone. A significant number of patients having dental malocclusion can brought into the treatment range of Invisalign® removable teeth aligner appliances with a prior short-term application of system 100. Additionally, many cases of malocclusion which are already treatable with Invisalign® removable teeth aligner appliances can be properly prepared for express treatment using Invisalign® removable teeth aligner appliances at a significantly overall reduced cost, and with less wear time by the patient.

After the application of system 100 has achieved results that improve the prognosis for application of removable orthodontic appliance systems, system 100 is removed from the patient, at block 1108, and then a conventional removable orthodontic realigner-retainer appliance system is applied to the patient, at block 1104.

FIG. 15 is a flowchart of a method 1500 to implement a unitary tooth-bonding-pad/archwire device, to correct orthodontic relapse. Method 1500 provides effective treatment for orthodontic patients whose prior orthodontic treatment has relapsed or regressed.

If orthodontic relapse is not diagnosed, at block 1502, then conventional post-treatment retention is performed. However orthodontic relapse is diagnosed at block 1502, because the degree of relapse is outside the range of treatment of a conventional realigner-retainer appliance, an appropriately selected implementation of system 100 is applied to the relapsed arches of the patient to bring the degree of orthodontic correction back within range of a realigner or a retainer, at block 1106.

After the application of system 100 has achieved results that improve the prognosis for application of removable orthodontic appliance systems, system 100 is removed from the patient, at block 1108, and the conventional orthodontic realigner/retainer appliance system is applied to the patient, at block 1506.

FIG. 13 is a flowchart of a method 1300 to implement a unitary tooth-bonding-pad/archwire device, to facilitate the application of interceptive removable orthodontic devices on patients who are in a mixed dentition age range. Patients who are in a mixed dentition age range have one or more teeth are positioned such that the implementation of interceptive devices are be contraindicated, these problematically positioned teeth can be moved into positions by system 100 to the extent that the new positions permit the implementation of these interceptive appliances.

When considering the use of a conventional interceptive orthodontic appliance for patients in the age range of mixed dentition if one or more malpositioned teeth contraindicate the use of conventional interceptive orthodontic appliances at block 1302, system 100 can be applied to the patient, at block 1106, to bring the malpositioned teeth into positions that permit the use of the conventional interceptive orthodontic appliance on the patient. If the patient has no malpositioned teeth that contraindicate the use of the conventional interceptive orthodontic appliance, then the conventional interceptive orthodontic appliance is applied in a conventional manner, at block 1304.

After the application of system 100 has achieved results that improve the prognosis for application of interceptive appliances, system 100 is removed from the patient, at block 1108, and the interceptive appliance is applied to the patient, at block 1306.

Interceptive orthodontic appliances include Frankel orthodontic appliances, Schwarz orthodontic appliances and Bionator orthodontic appliances. Method 1300 provides effective treatment for orthodontic patients who are in a mixed dentition age range.

FIG. 17 is a flowchart of a method 1700 to implement a unitary tooth-bonding-pad/archwire device, to correct a minor orthodontic malocclusion. Method 1700 provides effective treatment for orthodontic patients having a minor orthodontic malocclusion.

In method 1700, if a minor malocclusion in one or more arches is not diagnosed at block 1702, then no orthodontic treatment is performed at block 1704. However, if a minor malocclusion in one or more arches is diagnosed, at block 1702, in response to diagnosis of the minor orthodontic malocclusion, system 100 is applied to the patient, at block 1106, to correct the minor orthodontic malocclusion. An example of a minor orthodontic malocclusion is a dental malocclusion that includes only minor tooth displacements, such as buccal-lingual displacements, rotations, tipping, and/or vertical height discrepancies.

After the application of system 100 has corrected the minor orthodontic malocclusion, system 100 is removed from the patient, at block 1108.

In some implementations, following completion of orthodontic treatment involving system 100, any conventional orthodontic retainer, such as a Hawley orthodontic appliance, is applied to the patient at block 1706 to retain the orthodontic result.

FIG. 18 is a flowchart of a method 1800 to implement a unitary tooth-bonding-pad/archwire device, in coordination with application of crowns and abutments.

System 100, device 200 and device 500 can be implemented prior to crown and bridge work in dentistry. When one or more of teeth that are to be prepared for crowns or as abutments for bridgework are in less than ideal positions, system 100 can be implemented to better position these teeth for stress bearing associated with chewing forces, and also to allow for a more aesthetically appearing cosmetic result. For example, for teeth which are tipped or displaced from ideal positions of the teeth, orthodontic correction toward ideal positions of the teeth would permit the forces of mastication to be correctly directed along the long axis of the tooth, instead of producing periodontally unhealthy excessive lateral force components. Also, when anterior crowns are applied, significant labial-lingual misalignment can often be greater than can be compensated by selective tooth reduction alone. When the labial-lingual misalignment is greater than can be compensated by selective tooth reduction alone, short term correction involving system 100 aligns the anterior teeth so that conservative crown preparation will allow for a cosmetically ideal result.

If conventional preparation of a crown or a bridge is not contra-indicated because of tooth misalignment, at block 1802, the conventional preparation of a crown or bridge without using system 100 is performed, at block 1804. However, if conventional preparation of a crown or a bridge is contra-indicated because of tooth misalignment, at block 1802, then an appropriately selected implementation of system 100 is applied to the patient to better position the teeth for stress bearing associated with chewing force, at block 1106.

After the application of system 100 has achieved results that improve the prognosis for application of crowns and/or bridges, system 100 is removed from the patient and the tooth or teeth are conventionally prepared for an ideal crown or bridge result and a temporary crown or bridge coverage is applied based on conventional techniques, at block 1108, and conventional preparation of a crown or bridge without using system 100 is performed, at block 1804.

The methods disclosed herein do not include attaching or including a bracket to the device.

### Conclusion

A unitary tooth-bonding-pad/archwire system that does not include an orthodontic bracket is described herein.

In one implementation, an orthodontic archwire each has six tooth bonding pads attached in specified locations.

Although specific implementations are illustrated and described herein, it will be appreciated by those of ordinary skill in the art that any arrangement which is calculated to achieve the same purpose may be substituted for the specific implementations shown. This disclosure is intended to cover any adaptations or variations. For example, one of ordinary skill in the art will appreciate that implementations can be made in any material or any other process that provides the required function.

In particular, one of skill in the art will readily appreciate that the names of the methods and apparatus are not intended to limit implementations. Furthermore, additional methods and device can be added to the components, functions can be rearranged among the components, and new components to correspond to future enhancements and physical devices can be introduced without departing from the scope of implementations. One of skill in the art will readily recognize that implementations are applicable to new archwires and different tooth-bonding-pads.

The terminology in this disclosure is meant to include all archwires and tooth-bonding pads and alternate technologies which provide the same functionality as described herein.

In some of the implementations of permanent attachment, the permanent attachment is a semi-permanent attachment, such as a removable attachment.

1. A device consisting of:
a first apparatus consisting of an archwire having a sheathing; and
a second apparatus consisting of a plurality of tooth-bonding-pads, wherein each of the plurality of tooth-bonding-pads is permanently fabricated to the sheathing of the first device at fixed positions of the archwire of the first device,
not having an orthodontic bracket.

2. The device of claim 1, wherein each of the plurality of tooth-bonding-pads being permanently fabricated to the sheathing of the archwire further comprises:
at least one of the plurality of tooth-bonding-pads are formed as one complete integral unit with the archwire and the sheathing.

3. The device of claim 1, wherein each of the plurality of tooth-bonding-pads being permanently fabricated to the sheathing of the archwire further comprises:
at least one of the plurality of tooth-bonding-pads are permanently fabricated to the sheathing of the archwire through a welding/brazing method that is appropriate for the materials of the archwire, the sheathing and the tooth-bonding-pad.

4. The device of claim 1, wherein each of the plurality of tooth-bonding-pads being permanently fabricated to the sheathing of the archwire further comprises:
at least one of the plurality of tooth-bonding-pads are welded to the sheathing of the archwire.

5. (canceled)

6. The device of claim 1, wherein each of the plurality of tooth-bonding-pads being permanently fabricated to the sheathing of the archwire at fixed positions of the archwire further comprises:
at least one of the plurality of tooth-bonding-pads are glued to the archwire at fixed positions of the sheathing of the archwire.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. The device of claim 1, wherein each of the plurality of tooth-bonding-pads being permanently fabricated to the sheathing of the archwire further comprises:
each of the plurality of tooth-bonding-pads is permanently fabricated onto the sheathing of the archwire.

19. The device of claim 1, wherein each of the plurality of tooth-bonding-pads being permanently fabricated to the sheathing of the archwire further comprises:
each of the plurality of tooth-bonding-pads is permanently fabricated into the sheathing of the archwire.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. (canceled)

123. (canceled)

124. (canceled)

125. (canceled)

126. (canceled)

127. (canceled)

128. (canceled)

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. (canceled)

141. (canceled)

142. (canceled)

143. (canceled)

144. A device consisting of:
a tooth-bonding-pad having a passageway, the passageway extending through the tooth-bonding-pad along a mesial-distal length and perpendicular to an occlusal-gingival length; and
an archwire passing through the interior of the passageway and permanently attached to the interior of the passageway,
not having an orthodontic bracket.

145. The device of claim 144, wherein the tooth-bonding-pad further comprises:
at least one contour of each of the tooth-bonding-pads being produced from existing statistical norms of the labial and buccal surfaces of human teeth.

146. The device of claim 144, wherein the tooth-bonding-pad further comprises:
an occlusal-gingival height in a range of 0.1 mm to 3.0 mm and the mesial-distal length in a range of 1.5 mm to 3.5 mm.

147. The device of claim 144, wherein the tooth-bonding-pad further comprises:
a tooth-color as a result of manufacturing with epoxy coatings.

148. A device consisting essentially of:
a tooth-bonding-pad having a passageway, the passageway extending through the tooth-bonding-pad along a mesial-distal length and perpendicular to an occlusal-gingival length; and
an archwire passing through the interior of the passageway and permanently attached to the interior of the passageway,
not having an orthodontic bracket.

149. The device of claim 148, wherein the tooth-bonding-pad further comprises:
at least one contour of each of the tooth-bonding-pads being produced from existing statistical norms of the labial and buccal surfaces of human teeth.

150. The device of claim 148, wherein the tooth-bonding-pad further comprises:
an occlusal-gingival height in a range of 0.1 mm to 3.0 mm and the mesial-distal length in a range of 1.5 mm to 3.5 mm.

151. The device of claim 148, wherein the tooth-bonding-pad further comprises:
a tooth-color as a result of manufacturing with epoxy coatings.

152. (canceled)

153. (canceled)

154. (canceled)

155. (canceled)
